(19) United States
(12) Patent Application Publication
(10) Pub. No.: US 2019/0260973 A1
(43) Pub. Date: Aug. 22, 2019

(54) RAIL VEHICLE UNDERFRAME INSPECTION DEVICE AND CORRESPONDING INSPECTION METHOD

(71) Applicant: ALSTOM Transport Technologies, Saint-Ouen (FR)

(72) Inventor: Norbert BEHETY, HAGUENAU (FR)

(21) Appl. No.: 16/278,721

(22) Filed: Feb. 19, 2019

(30) Foreign Application Priority Data
Feb. 22, 2018 (FR) 18 51507

(51) Int. Cl. H04N 7/18; G06T 7/00; B61L 27/00; B25J 9/16

(52) U.S. Cl. CPC H04N 7/185; G06T 7/0004; H04B 1/38; B61L 27/0005; B25J 9/1674; B61L 27/0094

(57) ABSTRACT

Rail vehicle underframe inspection device that is designed to move under a rail vehicle between the rails of the railway track of the rail vehicle, characterized in that it includes a motor system designed to move the inspection device along the rails, an application block including at least one element of an image sensor that is designed to capture images under the frame of the inspected rail vehicle, and a measuring device that is designed to perform measurements relating to the underframe, wherein the application block is designed to deliver data captured or measured by the element to a processing block, the processing block is designed to process the data delivered by the application block and to determine the inspection status of the inspected rail vehicle as a function of at least the processed data.

### CROSS-REFERENCE TO RELATED APPLICATIONS

This application claims priority of French Patent Application No. 18 51507, filed on Feb. 22, 2018.

### FIELD OF THE INVENTION

The present invention relates to the field of maintenance inspections of rail vehicles, which must take place at regular intervals in order to ensure their integrity and thus the safety of people and goods transported.

### BACKGROUND OF THE INVENTION

These inspections are visual inspections carried out by human operators. They require the installation of rail vehicles on dedicated railway tracks (rails over pits, raised rails, etc.), which affects the availability of the rail vehicles, requires them to make specific journeys, and contributes to the saturation of infrastructures, while imposing unhelpful working conditions on human operators, and that are unfavorable in terms of health and safety. In addition, as 90% of the inspected bodies are determined to be compliant at the end of the inspection, a loosening of the concentration required for these inspections may be feared.

### SUMMARY OF THE DESCRIPTION

To this end and according to a first aspect, the invention proposes a rail vehicle underframe inspection device that is designed to move under a rail vehicle between the rails of the railway track of the rail vehicle, characterized in that it includes:
a motor system that is designed to move the inspection device along the rails;
an application block including at least one element among an image sensor designed to capture images under the frame of the rail vehicle being inspected, and a measuring device that is designed to perform measurements relating to the underframe, wherein the application block is designed to deliver data captured or measured by the element to a processing block;
a processing block that is designed to process the data delivered by the application block, and to determine the inspection status of the inspected rail vehicle as a function of at least the processed data.

Such a rail vehicle underframe inspection device allows easy access to underframe areas including all the equipment and components that are located under the frame (for example: wheels, axles, gearboxes, brake components, wiring, disks, etc.), without the need for specific movements of the rail vehicle or special maintenance tracks, while allowing human operators to work in a comfortable environment. The rail vehicle underframe inspection device also makes it possible to systematize the inspection tasks and the decision-making process as well as to accelerate them, thus reducing the inspection time and the risk of error. An alarm can only be generated in the event of the detection of a fault or failure of the inspection process.

In embodiments, the rail vehicle frame inspection device according to the invention further includes one or more of the following features:
the processing block is also designed to control the motor system according to an operating mode and as a function of control commands received in real time from a monitoring station via a wireless telecommunications receiver or as a function of predefined control sequences stored in a memory of the inspection device, or as a function of commands delivered to the processing block by the application block;
the inspection device further includes a detachable articulated arm, and is designed to detect a potentially dangerous circumstance, and, in the event of such a detection, to switch to a safety mode including stopping the movement of the inspection device along the rails, and retracting the articulated arm when the articulated arm is installed on the inspection device;
the inspection device is designed to detect any potentially dangerous circumstance of one or more of the following types: loss of communication with the monitoring station, insufficient power supply level, movement of the rail vehicle being inspected, loss of the ability of the inspection device to locate the presence of an obstacle in the direction of movement of the inspection device;
the inspection device includes a wireless telecommunication transmission and reception block that is designed to transmit captured or processed images to a monitoring station;
the processing block is further designed to identify which component of the rail vehicle appears on a captured image, in order to select, according to the identified component, an inspection computer program to detect anomalies on the component, and to provide the inspection status following the execution of the program, and to transmit the image data associated with an information field indicating the inspection status, to the monitoring station via the transmission and reception block;
the inspection computer program detects whether the component has an anomaly as a function of the captured image, characterizes a detected anomaly, and indicates the anomaly detected and its characterization, in the information field or in the image data to be transmitted;
the inspection device includes a specified interface with the application block, in which the application block mounted on the inspection device is removable and interchangeable with another application block of a set of application blocks having an interface that allows interfacing with each other; via the specified interface, and in which commands from an application block from the set of application blocks that is mounted on the inspection device, and which are intended for the processing block or, vice versa, from the processing block to the application block, and relating to image processing or measurements or displacement, are implemented by their recipient only upon successful completion of a matching process between the application block and the processing block, wherein the application block must present a code stored in the processing block and in the application block prior to mounting the application block on the inspection device;
the inspection device is portable.

According to a second aspect, the invention proposes a rail vehicle underframe inspection method using an inspection device, which is designed to move under a rail vehicle between the rails of the railway running track of the rail vehicle, wherein the method includes the following steps:
moving along the rails of the inspection device;
capturing, by the application block, images under the frame of the rail vehicle inspected, or measurements by the application block, relating to the underframe by the device; and delivering to the processing block the captured or measured data;
processing, by the processing block of the inspection device, data delivered by the application block, and determining, by the processing block, an inspection status of the inspected rail vehicle as a function of at least the processed data.

### BRIEF DESCRIPTION OF THE DRAWINGS

These features and advantages of the invention become apparent upon reading the description which follows, given solely by way of example, and with reference to the appended drawings, wherein:

FIG. 1 shows a schematic view of a rail vehicle underframe inspection device in an embodiment of the invention;

FIG. 2 shows a functional view of a rail vehicle underframe inspection device in an embodiment of the invention;

FIGS. 3 and 4 show schematic views of deployment situations of the arm of a rail vehicle underframe inspection device in an embodiment of the invention; and

FIG. 5 shows a flowchart of steps implemented in an embodiment of the invention.

### DETAILED DESCRIPTION

This inspection device 10 includes in the case in question a robot 1 and an application block 2. It is designed to inspect the frame of a rail vehicle (not shown) located on the rails of a railway track 7. The vehicle inspected, powered or not, may be a locomotive, a car, a wagon of a train, or a tram, etc.

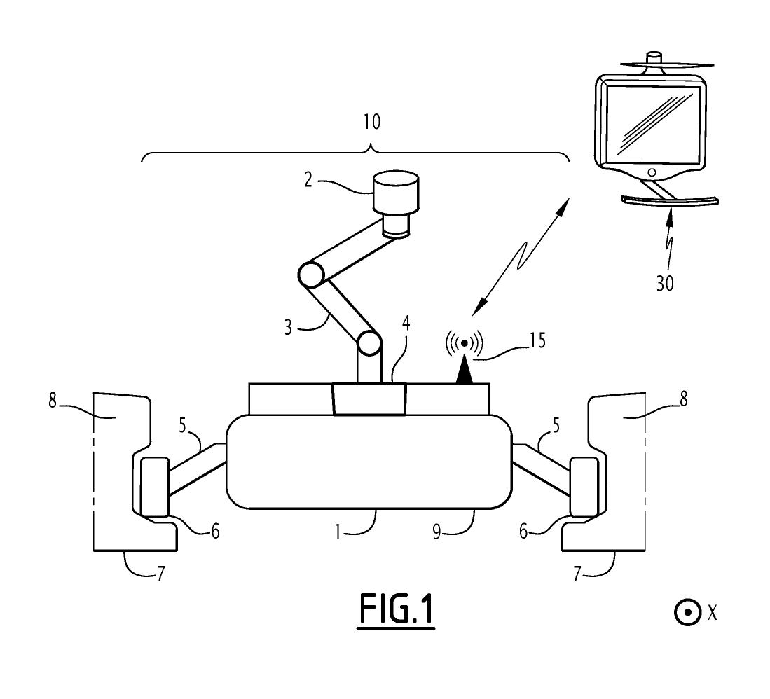

The railway track 7, in this case, extends perpendicular to the plane of FIG. 1, along the axis X. This track 7 on which the rail vehicles circulate along the X axis, or station, especially during a maintenance inspection, includes two rails 8 extending parallel to the axis X.

The robot 1 includes a base 9 and, in the case in question, an arm 3, which is articulated with 6 axes of rotation.

The base 9 houses elements (not shown) such as a motor, a battery, an inertial unit, smart cards carrying one or more microcontrollers, and memories that are used to perform various algorithmic processing operations, including processing of images and the detection of anomalies. The base 9 includes wheels 6, for example four wheels, wherein each wheel is driven in rotation by the motor via a shaft 5.

In the case in question, the wheels 6 are arranged on the rails 8, wherein two wheels are on the left rail, while the other two wheels are on the right rail. The displacement of the inspection device 10 under the effect of driving the wheels 6 by the motor via the shafts 5, is along the rails, between the rails, wherein the inspection device 10 is thus guided by the rails that serve as their support.

In another embodiment, guiding members that are designed to cooperate with the rails in guiding the inspection device along the rails, for example between the rails, are installed. For example, wheel tracks, dedicated to guiding the robot and parallel to the rails, are fixed to the rails.

The arm 3, an optional accessory of the inspection device, is a removable articulated arm 3, whose position is adjustable and controllable by means of commands that are transmitted to it by the robot 1 when it is installed on the base 9 in order to position the application block 2, when the latter is disposed on the arm to inspect the various components of the rail vehicle at selected locations.

In the case shown in FIG. 1, the arm 3 is present in the inspection device 10 and the application block 2 is connected to the end of the arm 3 which is opposite the base 9. In other configurations, the application block 2 is connected directly to a mounting adapter taking the place of the foot 4 of the arm, wherein the arm 3 is then not installed on the base 9 (the same interfaces of this mounting adapter are present in the application block 2 at the end of the arm 3 which is opposite the base 9).

The application block 2 includes, depending on the case, a sensor and/or a measuring device.

The application block 2 includes, in the present case, an image sensor. In one embodiment, it is, for example, removable and may be replaced in the inspection device 10 by another application block provided with electrical, mechanical and functional interfaces that are able to interface with the robot 1.

The base 9 further includes an interface 15 designed for wireless communication with a remote monitoring station 30, in particular for transmitting to the station 30 the images captured by the image sensor 2 (and/or measurements, if the application block 2 includes a measuring device), and for receiving commands from the data station 30, for example, in a so-called manual mode, for the elements of the inspection device 10 via a processing block of the inspection device, wherein the commands indicate, for example, movements to be made by the inspection device, image capture or measurements or analyses to be effected, etc.

The monitoring station 30 including a man-machine interface 32 (for example, equipped with a screen and a keyboard), is designed for the keyboard input of operator commands and for transmission by wireless communication, of the commands to the inspection device 10. The monitoring station 30 is further designed to display on the screen images (and/or measurements) and other data transmitted by the inspection device 10 and intended for the operator.

The inspection device 10 is portable; in the embodiment in question, the inspection device is of a weight that may be carried easily by a maintenance operator as a single assembly or in easily removable subassemblies, (for example, all or each subassembly of less than 20 kg: for example, from 10 to 20 kg).

The inspection device 10 has dimensions allowing it to move under a rail vehicle on the railway track (for example 1200×1200×200 mm³, without the arm).

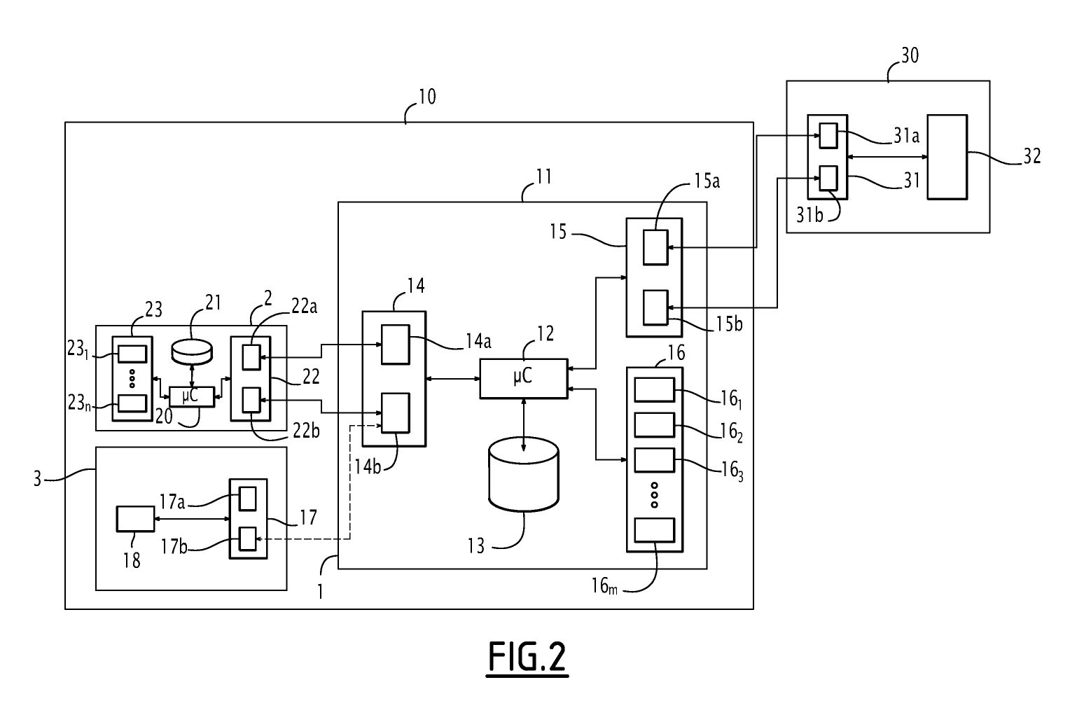

FIG. 2 shows a partial functional view of an assembly including a rail vehicle frame inspection device 10 in an embodiment of the invention, and a monitoring station 30.

Thus a processing block 11 of the inspection device 10, located in the base 9, includes an interface 14 that is intended, in particular, for interchanges with the application block 2, and also with the arm 3 when the arm is connected to the base 9.

In this case, the interface 14 includes an interface 14a of the Wi-Fi wireless communication type and a USB type interface 14b.

The processing block 11 includes an interface 15 that is intended for interchanges with the monitoring station 30. In the case in question, the interface 15 includes, in particular, an interface 15a of the Wi-Fi wireless communication type, and a radio type interface 15b.

The processing block 11 includes a microcontroller 12 and a memory 13. The memory 13 is designed to store data, in particular, computer programs including software instructions, which, when executed by the microcontroller 12, implement various processing operations as indicated below.

The processing block 11 also includes an assembly 16 of modules 16₁ to 16ₘ, among which a power supply module 16₁, for example an electric battery that is intended to supply electrical energy to the inspection device 10, a motor system 16₂ that is designed to drive the wheels 6 in rotation and cause movement of the inspection device 10 in accordance with displacement commands transmitted to it by the microcontroller 12, a geolocation module 16₃ including an inertial unit, . . . , an obstacle detector 16ₘ.

In one embodiment, the electric battery 16₁ is designed to provide a power failure alarm to the microcontroller 12 if the available energy level falls below a set threshold.

The geolocation module 16₃ is designed to determine the current position of the inspection device 10 according to data regularly provided by the inertial unit. The geolocation module 16₃ is further designed, in one embodiment, to provide a non-localization alarm to the microcontroller 12 when the current position of the inspection device 10 cannot be determined.

The obstacle detector 16ₘ is designed to detect any movement of a rail vehicle being inspected, as well as any obstacle in the direction of movement of the inspection device, for example by laser telemetry such as Lidar® sensors, and to provide the micro-detector 12 with a movement alarm when it detects a movement of a rail vehicle being inspected, and an obstacle alarm when it detects an obstacle in the direction of movement of the inspection device.

The arm 3 includes a system 18 of controllable actuators and an interface 17 for interchanges with the interface 14 of the processing block 11. The interface 17 includes a USB type interface 17b.

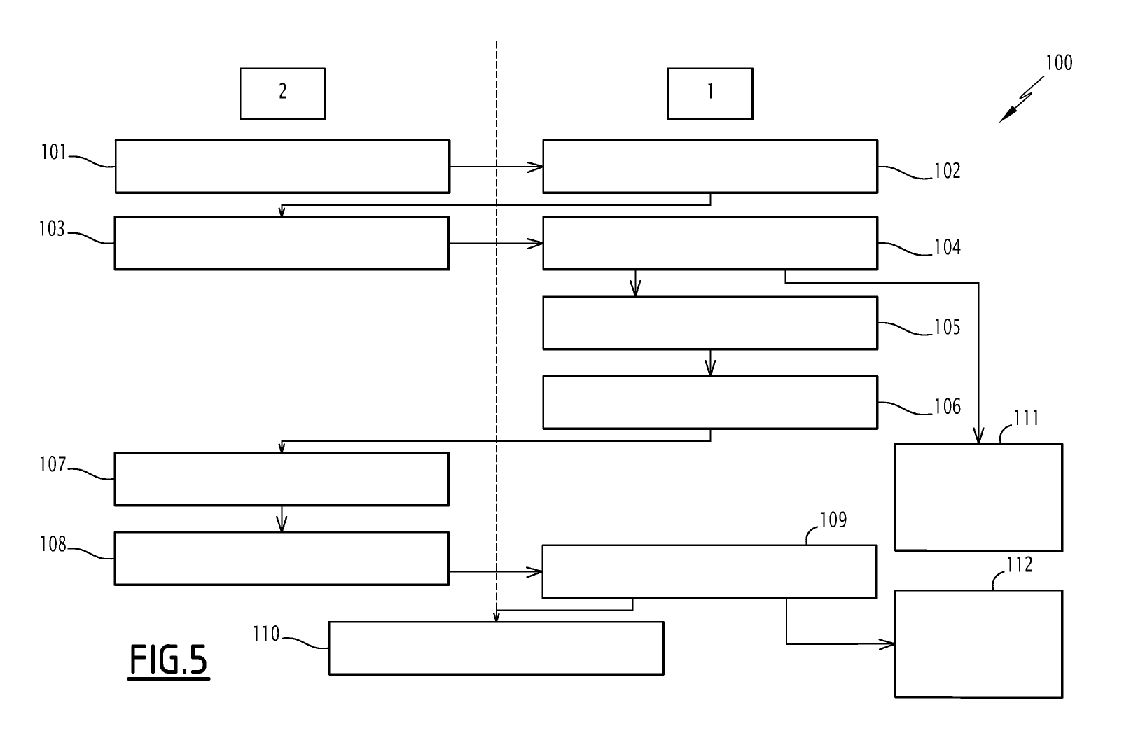

In the case in question, the actuator system 18 includes pivots that may be set in rotation by commands and are arranged between the consecutive sections 3.1, 3.2, 3.3, 3.4 of the arm 3, wherein the direction of rotation is indicated by arrows in FIG. 5. In addition, section 3.1 engages with the base 9 and section 3.4 that is intended to carry the application block 2, are designed to turn upon themselves in the direction indicated by the arrows in FIG. 5. The system 18 of actuators is designed to apply rotation to all of these elements based on provided commands.

The application block 2 includes, in the case in question, a microcontroller 20, a memory 21, an interface 22 for interchanges with the interface 14 of the processing block 11, and an application module 23.

The application module 23 includes n (n≥1) devices 23₁, . . . , 23ₙ: sensors, measuring devices, . . . , in this case, an image sensor.

The interface 22 includes a Wi-Fi wireless communication type interface 22a and a USB type interface 22b (the latter is connected to the interface 14b via the mounting adapter of the base 9 when the application block 2 is mounted on the base 9, while it is connected with the interface 17b of the arm 3 when the application block 2 is mounted on the arm 3).

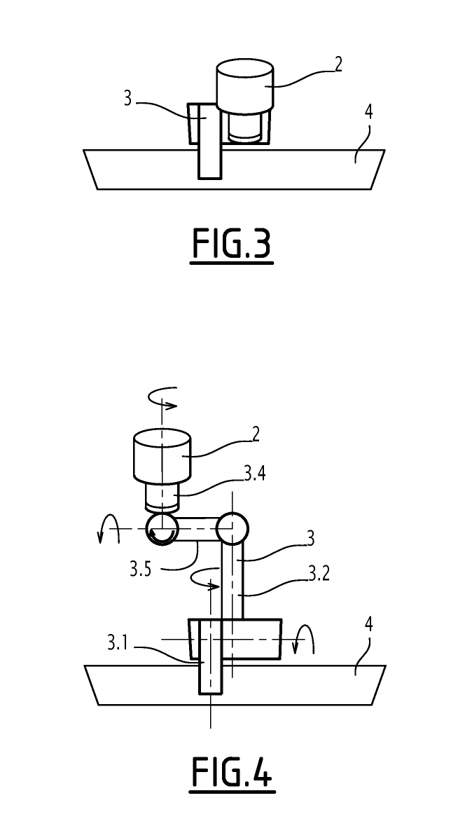

FIGS. 3 and 4 illustrate sectional views perpendicular to the X axis of some of the different configurations of deployment of the arm 3 mounted on the support 4 of the base 9, as a function of commands supplied to the actuator system 18.

FIG. 3 shows the arm 3 retracted to the maximum (the volume then occupied by the robot 10 with the retracted arm 3 is within the rail vehicle/track static gauge limits (the static template leaves a free space under the frame to avoid interference between the vehicle and equipment projecting onto the track). The arm 3 in the retracted position must not exceed the lower limit of the gauge, while FIG. 4 represents the arm 3 partially deployed (the height of the arm 3 beyond the pivot between sections 3.1 and 3.2 for a fully deployed arm is, for example, in a range of [0.5 m, 1 m], for example equal to 80 cm).

The inspection device 10 is designed to perform, in one embodiment, the elementary task commands GO, SEE, ANALYZE:

GO(M): controls a movement of the inspection device 10 along the track 8 and/or a positioning configuration of the arm 3, if necessary, to a position “M” indicated as the place of the task being commanded, from which an inspection may be carried out via the application device 2 in particular; the expected response to this command sent ultimately to the initial transmitter of the command (the processing block 10, the monitoring station 30, or the application block 2, according to the operating mode) is a confirmation of the correct positioning once the latter is executed;

SEE: command to the video sensor 2 to capture a video image (or a video stream), and to the processing block 11 to transmit to the station 30, or to an external server or internal memory of the inspection device 10, according to the data provided in arguments of this command, the image or the video stream thus captured with a quality that is compatible with the expected analysis of the component being inspected (it should be noted that if the application block 2 is a measuring system, a command will be addressed to it instead of SEE is MEASURE(.);

ANALYZE(.): Command to the processing block 11 to compare the image or the video stream with an already known reference, in order to determine an inspection status, for example, a status among the following 3 statuses: OK, NOT OK, Undetermined.

These tasks, isolated or combined in sequence, may be controlled by the inspection device 10 according to commands sent by an operator from the station 30 and received by the inspection device 10 via the interface 15 (in the mode referred to as “manual mode”). These commands are then optionally processed by the microcontroller 12, and then transmitted by the latter to the entity/entities concerned by the execution of the command, for example a module of the assembly 16, or the video sensor 2. These tasks may also be commanded by the inspection unit 10, by the application block 2 via the interfaces 22 and 14, or internally by commands previously stored in a computer program memory 13 and which are executed automatically on the microcontroller 12 (so-called “automatic mode”).

In one embodiment, the microcontroller 12 is designed to monitor the interface 15, and, as a result of this monitoring, to detect a break in communication with the monitoring station 30 in manual mode. If it detects such a communication break, it is further designed to switch to a security mode when it receives a power failure alarm 16₁ from the power supply module 16₁, a movement or obstacle alarm from the obstacle detector 16ₘ, or a non-location alarm from the geolocation module 16₃.

When the microcontroller 12 triggers the switchover to the safety mode, it supplies the motor system 16₂ with a stop command, as a result of which the motor stops, and the wheels 6 are locked, and, if the articulated arm 3 is installed on the base 9, the microcontroller 12 sends the necessary commands to the system 18 of actuators to trigger a low and centered position of the arm 3 in one embodiment, in order to trigger the maximum retraction of the articulated arm 3 corresponding to FIG. 3 in the embodiment in question.

Once in the security mode according to the embodiments, the inspection device 10 must remain inactive until the operator at the monitoring station 30 restarts its operation and/or it automatically resumes the task which was ongoing before the switchover, as a function of the event that caused the switchover, and/or after a period of inactivity, for example, 10 minutes in security mode, the inspection device 10 is designed to automatically switch to de-energized mode.

In one embodiment, the inspection device 10 is designed to detect other potentially hazardous circumstances instead of, or in addition to, those set out above, and in the event of such detections, also to engage the security mode.

Such arrangements allow the inspection device 10 to avoid mechanical interference with the rail vehicle under nominal operating conditions such as defective.

Furthermore, in one embodiment, the memory 13 further includes a correspondence table of the components of the rail vehicle to be inspected, indicating the description of the component and its position compared to a reference point of the rail vehicle. The memory 13 also includes computer programs for detecting anomalies each of which is specific to one of the components of the table.

Thus, in one embodiment, the inspection device 10 is designed to associate with the image data of each captured image, for example in a header field of the image file, the location coordinates x, y, z of the image sensor 2 corresponding to the captured image determined according to the current position of the inspection device 10 that is determined by the geolocation module 16₃ and the corresponding position of the arm 3, as well as the orientation of the image sensor 2.

The inspection device 10 is designed to identify, as a function of the x, y, z coordinates and the orientation of the image sensor 2 associated with a captured image, and, furthermore, of the positions of the rail vehicle components indicated in the table of components and, as a function of the actual position of the reference point of the rail vehicle, identify which component of the table appears in the captured image (or which piece of equipment was the object of capture, or measurement instead of the image sensor, a sensor of another type, or a measuring device on board the inspection device 10).

The position of the reference point of a rail vehicle is, for example, that of the axis of the first front axle of the rail vehicle.

The determination of the effective position of the reference point includes, for example, the determination of the orientation of the rail vehicle, since rail vehicles are not symmetrical. In one embodiment, it is performed automatically by the inspection device 10, or by the operator from the monitoring station 30 by detecting the position of the identifier of the first car of the rail vehicle.

The identification of the component appearing on a captured image may be carried out in one embodiment, by detecting an identifier of the component that is present on the image.

The inspection device 10 is further designed, once it has identified which component appears on the captured image, to select, if it exists, that of the computer programs for detecting anomalies stored in the memory 13 which is specific to the component thus identified, and to apply this specific program to the image.

In the context of the execution by the microcontroller 12 of the selected program, the inspection device 10 implements the following steps: a component-specific image analysis is performed in order to detect anomalies presented by the imaged component, at the end of which an output status of the detection is issued, for example selected from the following predetermined statuses:

A: when no anomaly has been detected;

B: anomaly detected with characterization of the anomaly;

C: anomaly detected without characterization of the anomaly;

D: image processing unavailable.

The characterization of the anomaly includes, for example, identifying the type of anomaly among a set of predetermined anomalies for the selected anomaly detection program, for example: crack, rust, etc.; the dimensions of the anomaly are, for example, estimated and its location may be highlighted on the image by the program delimiting the anomaly by a contour of the latter. The status is then recorded in a data field associated with the image, for example in a header field of the image file, as well as the characterization data where appropriate. And if the output status is B or C, a fault code is recorded in the inspection log.

When the status is C, the operator must give the characterization of the anomaly after reviewing the image.

The causes of a D status may be various, for example: no specific computer-specific anomaly detection program, corrupted image file, unidentified component. In such a case, the operator will have to provide a status after their analysis of the image.

Then the image file, with its header fields thus completed, is transmitted via the interface 15 to the monitoring station 30, for example, in order to be recorded in a base or to be processed by the operator where appropriate.

Thus, a specific image or measurement process is automatically performed by the inspection device 10, which makes it possible to avoid the addition of image transmission times.

Furthermore, the inspection device 10 is such that an application block 2 may be connected to the arm 3 or the base 9 via a mounting adapter, wherein this application block 2 operates under the control of the robot 1, or controls the robot 1. A standard open interface system of the inspection device 10, including specified mechanical, electrical, communication interfaces as well as specified protocols for controlling the inspection device and/or being controlled by the inspection device, is proposed to allow any compatible application block 2 to interface with it (after signing a license agreement), and to operate in “passive application block” or “active application block” mode.

In fact, in the “passive application block” mode, the application block 2 executes commands from the robot 1 (which may include the sending of data), while the robot 1 itself executes commands, for example, from the monitoring station 30. In an “active application block” mode, the application block 2 sends commands and data to the robot 1 and can receive commands from the monitoring station 30 via the interfaces 15, then 14, then 22. The “active application block” mode is engaged by a specific command from the robot 1 and is automatically canceled upon switching to security mode. The robot 1 is, for example, designed to exchange 3 types of information with both the monitoring station 30 and the application block 2:
data, for example image streaming;
commands: to control the positioning of the inspection device 10, or to initiate functions of the robot 1 or the application block 2;
files: to transfer files to the memories of the robot 1 or the application block 2, to the monitoring station 30, to USB memory cards, or to remote servers, typically to record images and videos.

The command-type information (also called commands) is processed by the monitoring station 30, the robot 1 and the application block 2 with the highest priority, while the file-type information is processed with the lowest priority.

USB may be used in one embodiment for the 3 types of information, while Wi-Fi is, for example, used for image streaming and file transfers. The robot 1 includes a Wi-Fi server and is accessible through a secure connection. A unique access code is associated with it. This code and the Wi-Fi initialization are transferred to the application block 2 via the USB interfaces 14b and 22b using a pairing sequence at the first connection based on the exchange of identification codes. Once the application block 2 is recognized by the processing unit 11 of the robot 1, the pairing step is no longer required. If the pairing fails, no further exchange between the application block 2 and the robot 1 can take place.

In one embodiment, an application block 2 is associated with a unique identifier (ID), including a type ID and a serial ID. The serial ID is assigned by the manufacturer of the application block 2. The type ID is provided by the manufacturer of the robot 1 to the manufacturer of the application block 2 through a license agreement. In one embodiment, the type ID is valid for a specified time, and pairing is no longer performed beyond that time.

The pairing method is, for example, as follows, with reference to the set of steps 100 shown in FIG. 5. Steps 101 to 107 are implemented via USB, while steps 108 and 109 are implemented via Wi-Fi. In step 101, the application block 2 connects to the robot 1 via the USB interfaces 22b and 14b. The robot 1, under the control of the processing block 11, then requests its ID from the application block 2 in step 102. In step 103, the application block 2 provides its ID to the robot 1. The robot 1 checks the validity of the type ID extracted from the ID provided in step 104. If this type ID is valid, then the robot 10 generates a new Wi-Fi code based on the serial ID extracted from the ID provided in step 105; and, in step 106, it provides it to the application block 2 and the USB connection may continue. The application block 2 receives the Wi-Fi code generated in step 107, and establishes in step 108 a Wi-Fi connection initialized with this received Wi-Fi code. The robot 10 checks in step 109 that the Wi-Fi code thus used to establish the Wi-Fi connection is the one generated in step 105. In the positive case, the Wi-Fi pairing is then also considered valid, and the Wi-Fi and USB connections may continue, and the commands may be sent by the monitoring station 30 to the application block 2 via the processing block 11 in the context of operating in “passive application block” mode or by the application block 2 to the processing block 11 in “active application block” mode.

If, in step 104, the ID is determined as invalid, the USB and Wi-Fi pairing fails in step 111 and no communication via Wi-Fi or via USB can be implemented between the application block 2 and the robot 10.

If in step 109, the verification fails, the Wi-Fi pairing is considered invalid, no Wi-Fi communication can take place; the USB connection may continue.

The inspection device 10 may be adapted to the main types of railway tracks (above pits, on ballast, on concrete beds, wooden or concrete sleepers, with fishplates, with bolted or attached rails), in certain cases requiring a dedicated support or a track.

The communication interfaces have been described above with USB and Wi-Fi, but, of course, other telecommunication standards may be used instead.

1. Inspection device for an underframe of a rail vehicle, that is designed to move under a rail vehicle between the rails of the railway track of the rail vehicle, comprising:
a motor system moving the inspection device along the rails;
an application block comprising at least one element among an image sensor capturing images under the frame of the rail vehicle being inspected, and a measuring device performing measurements relating to the underframe, wherein the application block delivers data captured or measured by said at least one element to a processing block; and
a processing block (i) processing data delivered by said application block, (ii) determining an inspection status of the inspected rail vehicle as a function of at least the processed data, (iii) identifying which component of the rail vehicle is in a captured image, (iv) selecting, according to the identified component, an inspection computer program to detect anomalies on the component, and (v) providing, upon completion of the program, the inspection status resulting from executing that program.

2. Inspection device according to claim 1, wherein said processing block controls said motor system according to an operating mode in accordance with control commands received in real time from a monitoring station via a wireless telecommunication receiver, or according to predefined command sequences stored in a memory of the inspection device, or according to commands delivered to said processing block by said application block.

3. Inspection device according to claim 1, further comprising a detachable articulated arm, wherein the inspection device detects a potentially dangerous circumstance, and, in the case of such circumstance detection, switches to a security mode including stopping the movement of the inspection device along the rails, and retracting the articulated arm when the articulated arm is installed on the inspection device.

4. Inspection device according to claim 3, wherein the inspection device detects potentially dangerous circumstances of one or more of the following types: loss of communication with a monitoring station, insufficient power supply, movement of the rail vehicle being inspected, loss of the inspection device's ability to locate itself, presence of an obstacle in the direction of movement of the inspection device.

5. Inspection device according to claim 1, further comprising a wireless telecommunication transmission and reception block transmitting captured or processed images to a monitoring station, wherein said processing block transmits to the monitoring station, via said transmission and reception block, image data associated with an information field indicating the inspection status.

6. Inspection device according to claim 1, wherein the inspection computer program detects whether the component has an abnormality as a function of the captured image, characterizes a detected abnormality, and indicates the anomaly detected and its characterization in the information field or in the image data to be transmitted.

7. Inspection device according to claim 1, comprising a specified interface with said application block, wherein said application block is mounted on the inspection device and is removable and interchangeable with any application block of a set of application blocks having an interface designed to interface with said specified interface, and in which commands from an application block of the application blocks, which is mounted on the inspection device, intended for said processing block or conversely from said processing block to the application block, and relating to image processing or measurements or displacement, are implemented by their recipient only following successful completion of a process of pairing between the application block and said processing block, wherein the application block presents a code stored in said processing block and in the application block prior to mounting the application block on the inspection device.

8. Inspection device according to claim 1, and weighing less than 20 kg or decomposable into subassemblies weighing less than 20 kg each.

9. Rail vehicle underframe inspection method using an inspection device according to claim 1, moving under a rail vehicle between the rails of the railroad track of the rail vehicle, the method comprising:
moving the inspection device along the rails;
capturing, by the application block, of images under the frame of the rail vehicle being inspected or measurements, by the application block, of data relating to the underframe;
delivering the captured or measured data to the processing block;
processing, by the processing unit of the inspection device, data delivered by the application block, comprising:
identifying which component of the rail vehicle appears on a captured image;
selecting, according to the identified component, an inspection computer program to detect anomalies on the component; and
providing, at the end of the execution of the program, the inspection status resulting from execution of the program; and
determining, by the processing block, the inspection status of the inspected rail vehicle as a function of at least the processed data.

10. Inspection method according to claim 9, wherein the inspection device includes a wireless telecommunication transmission and reception block transmitting captured or processed images to a monitoring station, the method further comprising transmitting, by the processing block to the monitoring station, via the transmission and reception block, the image data associated with a field of information indicating the inspection status.
